(19) United States
(12) Patent Application Publication
(10) Pub. No.: US 2026/0358768 A1
(43) Pub. Date: Nov. 12, 2026

(54) YELLOWING APPARATUS BASED ON MULTI-PHYSICS COUPLING AND METHOD FOR OPTIMIZING PROCESS PARAMETERS

(71) Applicant: ZHEJIANG UNIVERSITY, Hangzhou (CN)

(72) Inventors: Fangyuan Fan, Hangzhou (CN); Shuying Gong, Hangzhou (CN); Hong Qian, Hangzhou (CN); Hong Su, Hangzhou, Zhejiang (CN); Chuangsheng Huang, Hangzhou (CN); Qingyi Zeng, Hangzhou (CN); Wangqi Fang, Hangzhou (CN); Yong Hong, Hangzhou (CN)

(21) Appl. No.: 19/720,836

(22) Filed: Jun. 25, 2026

Related U.S. Application Data
(63) Continuation of application No. PCT/CN2025/095212, filed on May 15, 2025.

(30) Foreign Application Priority Data
May 16, 2024 (CN) 202410611876.3

(51) Int. Cl. G05B 13/02; A23F 3/06; G06N 3/084

(52) U.S. Cl. CPC G05B 13/027; A23F 3/06; G06N 3/084

(57) ABSTRACT

A yellowing apparatus based on multi-physics coupling is provided, which includes a drum, a blower device, a motor, a sensing system, and a control system. A method for optimizing process parameters using the yellowing apparatus based on multi-physics coupling is also provided, which includes: collecting data of temperature, relative air humidity, and air pressure inside the drum, as well as current motor power, and transmitting the data to the control system; if a yellowing time has not been reached, calculating current saturated water vapor pressure and air density; obtaining, using a real-time trained BP neural network, optimal PID regulation parameters and a reference power of the motor at a current moment; and then controlling a motor speed and a yellowing duration via PID control.

### CROSS REFERENCE TO RELATED APPLICATIONS

The present application is a Continuation Application of PCT Application No. PCT/CN2025/095212 filed on May 15, 2025, which claims the benefit of Chinese Patent Application No. 202410611876.3 filed on May 16, 2024. All the above are hereby incorporated by reference in their entirety.

### TECHNICAL FIELD

The present disclosure belongs to the technical field of tea processing apparatuses, and in particular, relates to a yellowing apparatus based on multi-physics coupling and a method for optimizing process parameters.

### BACKGROUND

Yellow tea is one of the six major tea types in China, and its characteristics of rich sweet aroma and mellow, sweet, and smooth taste have gained favor from an increasing number of consumers. Yellowing is a key process for forming the characteristic quality of yellow tea and is a process in which tea leaves after fixation or rolling gradually turn yellow under hydrothermal effect. Existing yellowing processes mostly employ conventional processing methods, which lack dedicated apparatuses and often use roasting baskets, fermenting machines, or other modified apparatuses, resulting in uneven heating of the tea leaves during the yellowing process, difficulty in controlling the yellowing process, and thus problems such as insufficient yellowing or excessive yellowing, leading to unstable product quality. In addition, such conventional methods tend to cause long yellowing durations, high labor intensity, and low production efficiency, which are direct factors restricting the mass production of yellow tea. Existing research on yellowing apparatuses for yellow tea has all adopted box-type yellowing boxes or yellowing chambers. For example, Chinese Patent Application Nos. 202210943882.X and 202210428480.6 disclose a yellowing apparatus for yellow tea, in which a heating plate and a fan are provided inside a box (chamber), and the yellowing box is further provided with a stirring rod that rotates to stir a tea leaf pile during accumulation, thereby promoting turning of tea leaves for uniform heating. Chinese Patent Application No. 202111614748.7 discloses a circulating air type yellowing apparatus for yellow tea processing, which adopts a box-type structure and is provided with a conveyor mesh belt inside for holding and transporting tea leaves under processing; the apparatus is equipped with a steam generator connected to a humidification pipeline for increasing the relative humidity of the yellowing environment; and a circulating air duct is constructed to achieve continuous air flow inside the box by means of air return. Chinese Patent Application No. 202210970628.9 discloses an intelligent yellowing production line for wet tea leaves of yellow tea. The tea leaves are transported via a conveyor belt to a yellowing room. The yellowing room is enclosed and internally provided with a pile-turning and heat-dissipating device, an energy-saving temperature regulating device, and a humidifying device. After yellowing is completed, the tea leaves are output from the yellowing room via the conveyor belt. Relevant research on technical parameters in yellowing process for yellow tea as disclosed in Chinese Patent Application No. 201710757588.9 shows that yellowing temperature, moisture content of tea leaves under processing, environmental relative humidity, and ventilation frequency are important process factors affecting the formation of yellow tea quality during yellowing. Within the conventional ranges of yellowing temperature (35 °C to 60 °C) and moisture content of tea leaves under processing (20% to 50%), appropriately increasing ventilation frequency and relative humidity of a yellowing environment within certain range can effectively improve yellow tea quality. For wet tea leaf yellowing, a yellowing leaf temperature of 43 °C to 54 °C, an environmental relative humidity of 61% to 83%, and a ventilation frequency at intervals of 10 min to 20 min are relatively optimal, resulting in pronounced characteristic styles of yellow tea with a sweet, moist, and mellow taste (Fan Fangyuan et al., “Study on the Effects of Yellowing Process Factors on the Quality and Taste Chemical Components of Yellow Tea,” Journal of Tea Science, 2019, 39(1), 63-73; Fan Fangyuan et al., “Mechanized Yellowing Processing Method for Yellow Tea”).

The above-described yellowing boxes/chambers all achieve setting and constant control of yellowing parameters through the devices, with the aim of making the yellowing of tea leaves more uniform and stable. However, on one hand, after tea leaves under processing enter the yellowing box/chamber, they mainly remain stationary or move in parallel with a chain plate, leaving the leaf pile unable to be turned or the leaf pile being too thin, or internal stirring causing uneven thickness of the leaf pile, all of which tend to result in non-uniform yellowing quality between the inner and outer portions of the leaf pile. Meanwhile, although air circulation can be achieved inside the box/chamber, there is a lack of air exchange within the leaf pile. On the other hand, the yellowing process is dynamically changing, and technical parameters in the process need to be coordinated within certain range. That is, as the state of the tea leaves under processing changes, a parameter system needs to be changed and adjusted to ensure normal yellowing, whereas constant control of set parameters cannot respond to the changes in the state inside the yellowing box/chamber. In view of this, achieving precise coupling sensing and control between the yellowing environment and the state of the tea leaves under processing, turning the leaf pile according to the state of the tea leaves under processing during yellowing to ensure consistency of the state between the inner and outer portions of the leaf pile, and adjusting the uniformity of the internal temperature field, humidity field, and airflow field to realize optimized coordinated regulation of temperature, humidity, and airflow, have important application value for breaking through the limitations of conventional parameter settings, achieving dual optimization of quality and energy consumption, and improving yellowing efficiency, quality retention capability, energy savings, and economic benefits.

### SUMMARY

The technical problem to be solved by the present disclosure is to provide a yellowing apparatus based on multi-physics coupling and a method for optimizing process parameters, so as to provide a novel temperature-humidity-airflow multi-physics coupling sensing and control yellowing drum device system, and to provide, based on the above device system, a method for adjusting power output using physical quantities such as temperature, humidity, and air pressure in combination with an adaptive BP neural network PID algorithm, thereby improving yellowing efficiency and enhancing yellowing quality.

To solve the above technical problem, the present disclosure provides a yellowing apparatus based on multi-physics coupling, which includes a drum and a control system.

The drum includes an outer fixed casing and an inner rotating drum. One end of the inner rotating drum is a conical inlet/outlet port, and the other end is an air inlet. A blower device, a drive device, and a sensing system are provided on the side of the air inlet. The drive device includes a motor, and the motor is respectively in transmission connection with the inner rotating drum and the blower device via belt transmission to respectively drive the inner rotating drum to rotate and drive the blower device to blow air into the inner rotating drum.

The control system includes a clock module, a BP neural network module, a central processing module, a motor power detector, and a variable frequency controller. The BP neural network module, the sensing system, and the clock module are respectively in signal communication with the central processing module.

The motor of the drive device is in signal communication with the central processing module via the variable frequency controller and the motor power detector.

As an improvement of the yellowing apparatus based on multi-physics coupling according to the present disclosure:

An inner wall of a drum body of the inner rotating drum is provided with leaf-guiding strips uniformly distributed along a length direction of the drum body.

An inner wall of the conical inlet/outlet port is provided with curved leaf-guiding blades uniformly distributed along the length direction of the drum body.

The sensing system is disposed between the outer fixed casing and the inner rotating drum, and the sensing system includes a temperature sensor, an air pressure sensor, and a humidity sensor.

As a further improvement of the yellowing apparatus based on multi-physics coupling according to the present disclosure:

A thermal insulation layer and a heating layer are disposed between the outer fixed casing and the inner rotating drum. The thermal insulation layer is tightly attached to an inner wall of the outer fixed casing, and the heating layer is disposed inside the thermal insulation layer and laid around the inner rotating drum. Both the thermal insulation layer and the heating layer are fixedly connected to the outer fixed casing.

As a further improvement of the yellowing apparatus based on multi-physics coupling according to the present disclosure:

The conical inlet/outlet port is provided with a drum cover, and the drum cover is controlled to open and close by a cover opening device. The cover opening device includes a bearing and an electric push rod. An outer ring of the bearing is in interference fit with the drum cover, and an inner ring of the bearing is in interference fit with a push rod of the electric push rod.

The present disclosure also provides a method for optimizing process parameters using the yellowing apparatus based on multi-physics coupling, which includes:
collecting, in real time by the temperature sensor, the air pressure sensor, and the humidity sensor, data of temperature, relative air humidity, and air pressure inside the drum, detecting, by the motor power detector, a motor power at a current yellowing time t, and transmitting the data to the central processing module; determining whether the current yellowing time t is less than a yellowing time tₘₐₓ, and if the yellowing time tₘₐₓ has been reached, turning off the motor; and if the yellowing time tₘₐₓ has not been reached, calculating a saturated water vapor pressure e_{w} and an air density ρ at the current yellowing time t, obtaining, using a real-time trained BP neural network, optimal PID regulation parameters K_{P}, K_{I}, K_{D} and a reference power Pₖ* of the motor at a current moment, and then performing PID control on a rotation speed of the motor and a yellowing duration by the variable frequency controller.

As an improvement of the method for optimizing process parameters using the yellowing apparatus based on multi-physics coupling according to the present disclosure:

The saturated water vapor pressure e_{w} is:

$${e}_{w} = k \times {e}^{( {AT}^{2} + BT + C + \frac{D}{T} )} \qquad ( 14 )$$

where e_{w} is the saturated water vapor pressure at temperature T; T is the temperature inside the drum; and k, A, B, C, and D are constants;
The air density ρ is:

$$ρ = 3.484 \times 1 {0}^{- 3} \times \frac{1}{T} ( p - 0.3 \; 78 φ {e}_{w} ) \qquad ( 15 )$$

where p is the air pressure inside the drum, and φ is the relative air humidity inside the drum.

As a further improvement of the method for optimizing process parameters using the yellowing apparatus based on multi-physics coupling according to the present disclosure:

The BP neural network includes an input layer, at least one hidden layer, and an output layer:
(1) inputs of the BP neural network are: the temperature, the humidity, the saturated water vapor pressure e_{w}, and the air density ρ inside the drum;
(2) inputs and outputs of the hidden layer are calculated according to a forward network of the BP neural network:

$${a}_{j} = f ( {\sum }_{i = 1}^{I} {w}_{ij} {x}_{i} + {b}_{j} ) , ( j = 1 , 2 , … , H ) \qquad ( 2 )$$

where xᵢ is an input vector, aⱼ is an output vector of the hidden layer, wᵢⱼ is a weight between the input layer and the hidden layer, bⱼ is a threshold between the input layer and the hidden layer, and f(⋅) is an activation function:

$$f ( x ) = \frac{1}{1 + {e}^{- x}} \qquad ( 3 )$$

(3) outputs of the BP neural network are: the motor reference power Pₖ*, a PID control proportional parameter K_{P}, a PID control integral parameter K_{I}, and a PID control derivative parameter K_{D}:

$${P}_{k}^{*} = f ( {\sum }_{j = 1}^{H} {w}_{jk} {a}_{j} + {b}_{k} ) , ( k = 1 , 2 , … , O ) \qquad ( 4 )$$

where wⱼₖ is a weight between the hidden layer and the output layer, and bₖ is a threshold between the hidden layer and the output layer;

$${K}_{P} = g ( {\sum }_{j = 1}^{P} {w}_{jk} {a}_{j} + {b}_{k} ) , ( k = 1 , 2 , … , O ) \qquad ( 5 )$$

$${K}_{I} = g ( {\sum }_{j = 1}^{I} {w}_{jk} {a}_{j} + {b}_{k} ) , ( k = 1 , 2 , … , O ) \qquad ( 6 )$$

$${K}_{D} = g ( {\sum }_{j = 1}^{D} {w}_{jk} {a}_{j} + {b}_{k} ) , ( k = 1 , 2 , … , O ) \qquad ( 7 )$$

where K_{P} is the proportional parameter, K_{I} is the integral parameter, and K_{D} is the derivative parameter,

$$g ( x ) = \frac{{e}^{x}}{{e}^{x} + {e}^{- x}} . \qquad ( 8 )$$

As a further improvement of the method for optimizing process parameters using the yellowing apparatus based on multi-physics coupling according to the present disclosure:

A real-time training process of the BP neural network includes:
performing normalization processing on the temperature T, the relative air humidity, the saturated water vapor pressure e_{w}, and the air density ρ inside the drum at the current time as well as the motor power, and using the normalized values as the inputs of the BP neural network; initializing the BP neural network, where the weights and the thresholds wᵢⱼ, wⱼₖ, bⱼ, and bₖ of the neural network are set as random numbers in an interval [0, 1], and initializing a learning coefficient η; and using a gradient descent algorithm to adjust the weights and the thresholds wᵢⱼ, bⱼ, wⱼₖ, and bₖ of the BP neural network according to the learning coefficient η, performing iterative learning until an error function E converges to a global minimum or a maximum number of training iterations is reached, and then stopping training to obtain optimal weights and thresholds of the BP neural network.

As a further improvement of the method for optimizing process parameters using the yellowing apparatus based on multi-physics coupling according to the present disclosure:

The error function E is:

$$E = \frac{1}{2} {\sum }_{k = 1}^{O} {( {P}_{k}^{*} - {P}_{k} )}^{2} , ( k = 1 , 2 , … , O ) \qquad ( 9 )$$

where Pₖ* is a reference power obtained after one forward computation of the neural network, and Pₖ is an actual value.

The weights and thresholds wᵢⱼ, bⱼ, wⱼₖ, and bₖ are:

$${w}_{ij}^{*} = {w}_{ij} + η \frac{\partial E}{\partial {w}_{ij}} \qquad ( 10 )$$

$${b}_{j}^{*} = {b}_{j} + η \frac{\partial E}{\partial {b}_{j}} \qquad ( 11 )$$

$${w}_{jk}^{*} = {w}_{jk} + η \frac{\partial E}{\partial {w}_{jk}} \qquad ( 12 )$$

$${b}_{k}^{*} = {b}_{k} + η \frac{\partial E}{\partial {b}_{k}} \qquad ( 13 )$$

where wᵢⱼ* is an updated weight between the input layer and the hidden layer, bⱼ* is an updated threshold between the input layer and the hidden layer, wⱼₖ* is an updated weight between the hidden layer and the output layer, and bₖ* is an updated threshold between the hidden layer and the output layer.

As a further improvement of the method for optimizing process parameters using the yellowing apparatus based on multi-physics coupling according to the present disclosure:

A PID control process includes:
determining whether the output motor reference power Pₖ* is less than a maximum power Pₘₐₓ of the motor, if Pₖ*≥Pₘₐₓ, then setting Pₖ*=Pₘₐₓ, and adjusting the motor according to the reference power Pₖ* and the PID parameters K_{P}, K_{I}, and K_{D}, and if Pₖ*<Pₘₐₓ, then directly adjusting the motor according to the reference power Pₖ* and the PID parameters K_{P}, K_{I}, and K_{D}.

A PID control calculation formula is:

$$u ( t ) = {K}_{P} \cdot E ( t ) + {K}_{I} \cdot {\int }_{0}^{t} E ( τ ) d τ + {K}_{D} \cdot \frac{dE ( t )}{dt} \qquad ( 17 )$$

where u(t) is an output of a PID controller at the current time, E(t) is an error function at the current time,

$${\int }_{0}^{t} E ( τ ) d τ$$

represents an integral of the error function E(t), and

$$\frac{dE ( t )}{dt}$$

represents a derivative of the error function E(t).

The beneficial effects of the present disclosure are mainly reflected as follows:

According to the present disclosure, the leaf pile is turned in a timely manner based on the state of the tea leaves under processing inside the yellowing drum, so as to ensure consistency of the state between the inner and outer portions of the leaf pile, and uniformity of the internal temperature field, humidity field, and airflow field is adjusted, thereby achieving precise coupling sensing and control between the yellowing environment and the state of the tea leaves under processing. Moreover, based on multiple physical quantities such as temperature, humidity, and air pressure, and in combination with an adaptive BP neural network PID algorithm, the motor power output is automatically controlled and adjusted, achieving optimized coordinated regulation of temperature, humidity, and airflow. This has important application value for breaking through the limitations of conventional parameter settings, achieving dual optimization of quality and energy consumption, and improving yellowing efficiency, quality retention capability, energy savings, and economic benefits.

### BRIEF DESCRIPTION OF THE DRAWINGS

The specific implementations of the present disclosure will be described in further detail below with reference to the accompanying drawings.

FIG. 1 is a schematic structural diagram of a yellowing apparatus based on multi-physics coupling according to the present disclosure (a is a front view, and b is a side view);

FIG. 2 is a principle diagram of a method for optimizing process parameters using a yellowing apparatus based on multi-physics coupling according to the present disclosure;

FIG. 3 is a schematic flowchart of a method for optimizing process parameters using a yellowing apparatus based on multi-physics coupling according to the present disclosure;

FIG. 4 is a schematic diagram of a process parameter optimization control process using a yellowing apparatus based on multi-physics coupling according to the present disclosure;

FIG. 5 is a schematic diagram of a BP neural network model; and

FIG. 6 is a schematic diagram of motor power during yellowing in examples and comparative examples according to the present disclosure.

### DETAILED DESCRIPTION

The present disclosure will be further described below in conjunction with specific examples, but the scope of protection of the present disclosure is not limited thereto.

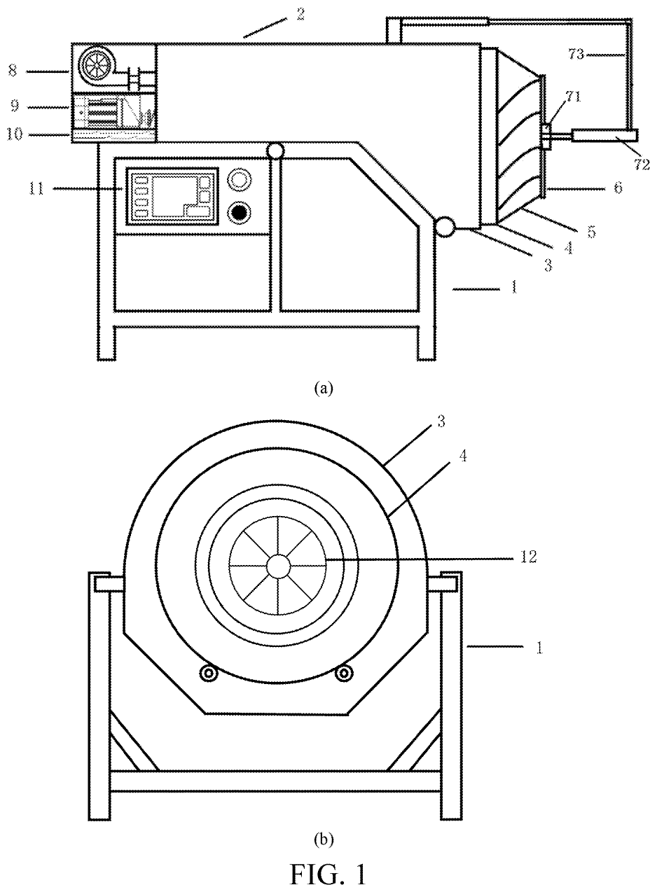

Example 1: A yellowing apparatus based on multi-physics coupling, as shown in FIG. 1, includes: a rectangular bearing frame 1, a drum 2, a drive device 9, a blower device 8, a sensing system 10, and a control system 11.

The drum 2 is a core component of the yellowing apparatus, is disposed on the rectangular bearing frame 1, and has a double-layer shell structure, including an outer fixed casing 3 and an inner rotating drum 4. The outer fixed casing 3 is fixedly connected to the rectangular bearing frame 1. A thermal insulation layer and a heating layer are disposed between the outer fixed casing 3 and the inner rotating drum 4. The thermal insulation layer is uniformly and tightly attached to an inner wall of the outer fixed casing 3 and is fixedly connected to the outer fixed casing 3, so as to maintain a specific high-temperature condition inside the drum. The heating layer is disposed inside the thermal insulation layer. The heating layer is laid around the inner rotating drum 4 using electric heating tubes and is fixedly connected to the outer fixed casing 3 via brackets (i.e., the heating layer is separate from and not fixed to the inner rotating drum 4, such that the inner rotating drum 4 rotates relative to the heating layer to achieve uniform heating and temperature increase), so as to provide a high-temperature yellowing environment inside the inner rotating drum 4.

One end of the inner rotating drum 4 contracts outward to form a conical inlet/outlet port 5 for feeding fresh tea leaves and discharging tea leaves that have completed yellowing, and the other end is an air inlet. A filter screen 12 is arranged at the air inlet for filtering incoming fresh air, and the filter screen 12 is detachably connected to the air inlet for periodic replacement. Leaf-guiding strips are uniformly distributed on an inner wall of a drum body of the inner rotating drum 4. The leaf-guiding strips have a length slightly shorter than that of the drum body and a height of about 3 to 4 cm, and are fixedly connected to the inner wall of the drum body along a length direction of the drum body, so as to assist in turning over the tea pile during the yellowing process. Similarly, curved leaf-guiding blades are uniformly distributed on an inner wall of the conical inlet/outlet port 5 along the length direction of the drum body. The curved leaf-guiding blades are fixedly connected to the inner wall of the conical inlet/outlet port 5 and can also rotate together with the inner rotating drum 4. When rotating forward, the curved leaf-guiding blades guide the material into the drum, and when rotating backward, the curved leaf-guiding blades guide the material out of the drum, thereby assisting in material feeding and discharging.

A drum cover 6 is arranged on the conical inlet/outlet port 5. The drum cover 6 tightly fits against the conical inlet/outlet port 5 but is not fixed thereto, so as to seal the inner rotating drum 4. The drum cover 6 is controlled to open outward by a cover opening device. The cover opening device includes a bearing 71, an electric push rod 72, and a connecting bracket 73. An outer ring of the bearing 71 is fixedly connected to the drum cover 6 via interference fit, and an inner ring is fixedly connected to a push rod of the electric push rod 72 via interference fit. A casing of the electric push rod 72 is fixedly connected to the rectangular bearing frame 1 via the connecting bracket 73. The drum cover 6, the inner rotating drum 4, the conical inlet/outlet port 5, the bearing 71, and the electric push rod 72 are coaxially aligned. When the push rod of the electric push rod 72 is retracted backward, the drum cover 6 is opened outward. When closing, the push rod of the electric push rod 72 is extended forward, causing the drum cover 6 to tightly fit against the conical inlet/outlet port 5. When the inner rotating drum 4 rotates, due to the action of the bearing 71, the drum cover 6 maintains sealing of the inner rotating drum 4 while being able to rotate together with the inner rotating drum 4.

The drive device 9 and the blower device 8 are both disposed on the side of the air inlet of the inner rotating drum 4. The blower device 8 employs a centrifugal blower for intermittently ventilating the interior of the inner rotating drum 4. The inlet air of the centrifugal blower is natural air, and an air outlet of the centrifugal blower is connected to the air inlet of the inner rotating drum 4. When turned on, natural air enters the inner rotating drum 4 after being filtered by the filter screen 12 at the air inlet, and cooperates with the opening and closing of the drum cover 6 to complete air exchange, thereby ensuring air exchange within the tea pile.

The drive device 9 includes a motor. The motor is respectively in transmission connection with the inner rotating drum 4 and the blower device 8 via belt transmission to drive the rotation of the inner rotating drum 4 and the blowing of the blower device 8.

The sensing system 10 includes a temperature sensor, an air pressure sensor, and a humidity sensor. The temperature sensor, the air pressure sensor, and the humidity sensor are all disposed inside the drum 2 (between the outer fixed casing 3 and the inner rotating drum 4, and near the air inlet side of the inner rotating drum 4), are all fixedly connected to the outer fixed casing 3, and are all in signal communication with a central processing module, for respectively collecting data of temperature, air pressure, and humidity inside the drum 2 and transmitting the data to the central processing module.

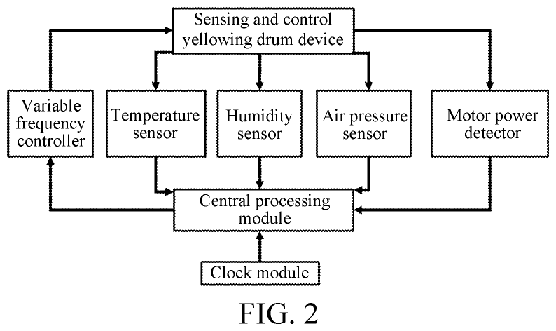

The control system 11 includes a clock module, a BP neural network module, the central processing module, a motor power detector, and a variable frequency controller. The BP neural network module and the clock module are each in signal communication with the central processing module. The motor of the drive device 9 is in signal communication with the central processing module via the variable frequency controller and the motor power detector. The variable frequency controller is configured to adjust an operating power of the motor according to a control signal from the central processing module. The motor power detector is configured to collect a power of the motor and transmit the collected data to the central processing module. The clock module is configured to provide a clock source to the central processing module. The BP neural network module is configured to train a neural network, obtain a motor reference power using a real-time learning neural network via calculation, and input the obtained reference power to the central processing module. The central processing module is configured to input the data collected by the sensors into the BP neural network module for training, and to calculate and obtain a reference power to generate a control signal for the variable frequency controller. The control process at any moment t is shown in FIG. 2.

The present disclosure provides a method for optimizing process parameters using the above-described yellowing apparatus based on multi-physics coupling. The method includes: collecting data of temperature, relative air humidity, and air pressure inside the drum 2 in real time, and detecting a motor power in real time, then inputting the data into the BP neural network module for training and calculating to obtain a reference power, and controlling a rotation speed of the motor and a yellowing duration according to the reference power, thereby achieving the processing of yellow tea. The method is specifically as follows:

### 1. BP Neural Network

### 1.1 Construction of BP Neural Network

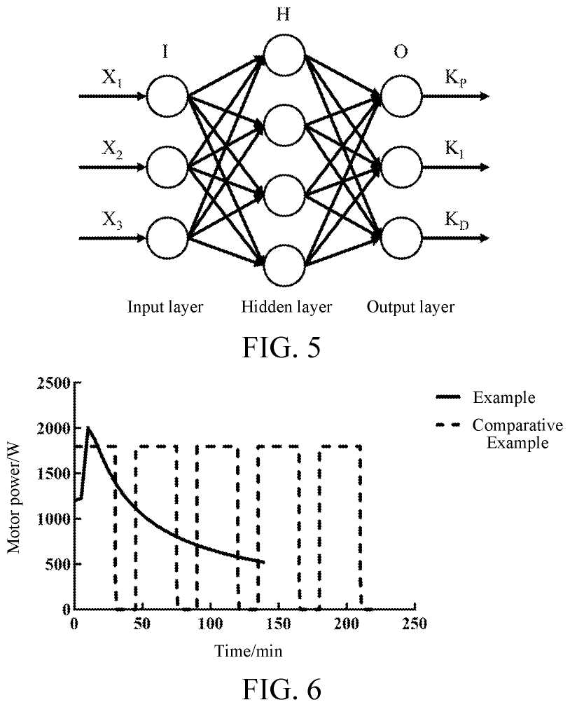

A BP neural network, also referred to as a backpropagation neural network, is a supervised learning algorithm. It has strong capabilities in self-adaptation, self-learning, and nonlinear mapping, can effectively solve problems involving limited data, scarce information, and uncertainty, and is not constrained by nonlinear models. A typical BP neural network should include three layers: an input layer, at least one hidden layer, and an output layer, as shown in FIG. 5. The layers are fully connected, while no connections exist within the same layer.
(1) The number of nodes in the input layer of the BP neural network is equal to the number of input variables, including a temperature T, a relative air humidity φ, a saturated water vapor pressure e_{w}, and an air density ρ inside the drum 2.
(2) The number of neurons in the input layer of the BP neural network is I, the number of neurons in the hidden layer is H, and the number of neurons in the output layer is O. The number of neurons in the hidden layer is:

$$\{ \begin{matrix}\frac{( I - O )}{2} \leq H \leq I + O + 10 \\ H = \sqrt{I + O} + r\end{matrix} \qquad ( 1 )$$

where r is a constant between 1 and 10. If the number of nodes in the hidden layer is too small, large deviations may be caused in the results, thereby causing oscillations and fluctuations. If the number of nodes is too large, overfitting may occur, reducing the stability of output results. The number of neurons in the hidden layer ranges from 4 to 13. To ensure that the accuracy and reliability requirements of the neural network are met and overfitting during the training process of the BP neural network is avoided at the same time, the present disclosure selects 8 as the number of nodes in the hidden layer.

Inputs and outputs of the hidden layer are calculated according to a forward network of the BP neural network:

$${a}_{j} = f ( {\sum }_{i = 1}^{I} {w}_{ij} {x}_{i} + {b}_{j} ) , ( j = 1 , 2 , … , H ) \qquad ( 2 )$$

where xᵢ is an input vector, aⱼ is an output vector of the hidden layer, wᵢⱼ is a weight between the input layer and the hidden layer, and bⱼ is a threshold between the input layer and the hidden layer.

f(⋅) is an activation function, i.e.,

$$f ( x ) = \frac{1}{1 + {e}^{- x}} \qquad ( 3 )$$

(3) The number of nodes in the output layer is equal to the number of output variables, and the output layer includes a motor reference power Pₖ*, a PID control proportional parameter K_{P}, a PID control integral parameter K_{I}, and a PID control derivative parameter K_{D}.

The reference power Pₖ* of the motor in the output layer is:

$${P}_{k}^{*} = f ( {\sum }_{j = 1}^{H} {w}_{jk} {a}_{j} + {b}_{k} ) , ( k = 1 , 2 , … , O ) \qquad ( 4 )$$

where wⱼₖ is a weight between the hidden layer and the output layer, and bₖ is a threshold between the hidden layer and the output layer.

The PID parameters in the output layer are:

$${K}_{P} = g ( {\sum }_{j = 1}^{P} {w}_{jk} {a}_{j} + {b}_{k} ) , ( k = 1 , 2 , … , O ) \qquad ( 5 )$$

$${K}_{I} = g ( {\sum }_{j = 1}^{I} {w}_{jk} {a}_{j} + {b}_{k} ) , ( k = 1 , 2 , … , O ) \qquad ( 6 )$$

$${K}_{D} = g ( {\sum }_{j = 1}^{D} {w}_{jk} {a}_{j} + {b}_{k} ) , ( k = 1 , 2 , … , O ) \qquad ( 7 )$$

where K_{P} is the proportional parameter, K_{I} is the integral parameter, K_{D} is the derivative parameter, and g(x) is a calculation function, i.e.,

$$g ( x ) = \frac{{e}^{x}}{{e}^{x} + {e}^{- x}} \qquad ( 8 )$$

### 1.2 Training of BP Neural Network

The present disclosure reads various real-time parameters within the system through the BP neural network, and feeds back and outputs PID control parameters. During use, the network is continuously trained and iterated according to different conditions to adapt and output new parameters, thereby quickly adjusting the yellowing process through a PID control method. To adjust an actual power of the motor in real time according to a state of tea leaves inside the drum, an error function E of the BP neural network is set as:

$$E = \frac{1}{2} {\sum }_{k = 1}^{O} {( {P}_{k}^{*} - {P}_{k} )}^{2} , ( k = 1 , 2 , … , O ) \qquad ( 9 )$$

where Pₖ* is a reference power obtained after one forward computation of the neural network, and Pₖ is an actual value.

A gradient descent algorithm is adopted to adjust the weights and the thresholds wᵢⱼ, bⱼ, wⱼₖ, and bₖ of the BP neural network according to a learning coefficient η:

$${w}_{ij}^{*} = {w}_{ij} + η \frac{\partial E}{\partial {w}_{ij}} \qquad ( 10 )$$

$${b}_{j}^{*} = {b}_{j} + η \frac{\partial E}{\partial {b}_{j}} \qquad ( 11 )$$

$${w}_{jk}^{*} = {w}_{jk} + η \frac{\partial E}{\partial {w}_{jk}} \qquad ( 12 )$$

$${b}_{k}^{*} = {b}_{k} + η \frac{\partial E}{\partial {b}_{k}} \qquad ( 13 )$$

where η is the learning coefficient, generally ranges from 0.01 to 0.8, wᵢⱼ* is an updated weight between the input layer and the hidden layer, bⱼ* is an updated threshold between the input layer and the hidden layer, wⱼₖ* is an updated weight between the hidden layer and the output layer, and bₖ* is an updated threshold between the hidden layer and the output layer. Iterative learning is continuously performed, the error function E is adjusted until it quickly converges to a global minimum or until a maximum number of training iterations is reached, and then training is stopped to obtain optimal weights and thresholds wᵢⱼ, bⱼ, wⱼₖ, and bₖ of the BP neural network.

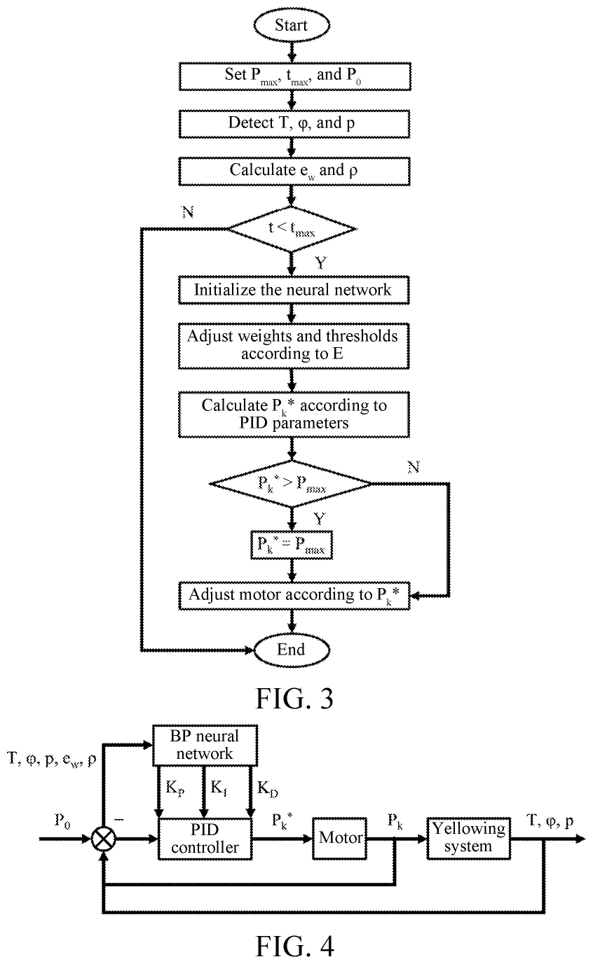

2. The real-time trained BP neural network is adopted to obtain the optimal PID regulation parameters K_{P}, K_{I}, and K_{D}, and the reference power Pₖ* of the motor of the drive device 9 for performing PID control. The control process at any moment t is shown in FIG. 3 and FIG. 4.
(1) A yellowing time tₘₐₓ and a maximum power Pₘₐₓ of the motor are set.
(2) The current temperature T, the relative air humidity φ, and the air pressure data p inside the drum 2 are collected at fixed time intervals (e.g., 0.02 s), and the current motor power is simultaneously detected by the motor power detector. The data is transmitted to the central processing module to calculate the saturated water vapor pressure e_{w} and the air density ρ inside the drum 2. The calculation formula (16) for the saturated water vapor pressure inside the drum 2 is derived from the Wexler-Greenspan water vapor pressure formula, and is as follows:

$${e}_{w} = k \times {e}^{( {AT}^{2} + BT + C + \frac{D}{T} )} \qquad ( 14 )$$

where e_{w} is the saturated water vapor pressure at temperature T; T is the temperature inside the drum 2; k=1 Pa; A, B, C, and D are constants, with A=1.237×10⁻⁵ K⁻²; B=−1.912×10⁻⁵ K⁻¹; C=33.937; and D=−6.343×10³ K.

The calculation formula for the air density inside the drum 2 is:

$$ρ = 3.484 \times 1 {0}^{- 3} \times \frac{1}{T} ( p - 0.3 \; 78 φ {e}_{w} ) \qquad ( 15 )$$

where ρ is the air density; p is the air pressure inside the drum 2, in Pa; and φ is the relative air humidity inside the drum 2.
(3) Whether the current yellowing time t is less than a preset yellowing time tₘₐₓ is determined. If the preset yellowing time tₘₐₓ has been reached, then the PID control process is terminated and the motor is turned off. If the preset yellowing time has not been reached, then the following PID control process based on the BP neural network is performed:

The temperature T, the relative air humidity φ, the saturated water vapor pressure e_{w}, and the air density ρ inside the drum 2 at the current time as well as the motor power are used as the inputs to the BP neural network. The BP neural network is initialized, where the weights and the thresholds wᵢⱼ, wⱼₖ, bⱼ, and bₖ of the neural network are set as random numbers in an interval [0, 1], and a learning coefficient n is initialized. The weights and the thresholds wᵢⱼ, wⱼₖ, bⱼ, and bₖ are adjusted according to the error function E to obtain the reference power Pₖ of the motor and the PID control proportional parameter K_{P}, the PID control integral parameter K_{I}, and the PID control derivative parameter K_{D}.

Because the units of the various parameters are different and there are significant differences in magnitude, failure to normalize the input data before input would seriously affect the weight of each parameter on the BP neural network. The input data of the BP neural network is normalized to the interval of [0, 1]. A normalization function is:

$${x}^{′} = \frac{x - {x}_{min}}{{x}_{max} - {x}_{min}} \qquad ( 16 )$$

Whether the output motor reference power Pₖ* is less than a maximum power Pₘₐₓ of the motor is determined. If Pₖ*≥Pₘₐₓ, then Pₖ*=Pₘₐₓ is set, the motor is adjusted according to the reference power Pₖ and the PID parameters K_{P}, K_{I}, and K_{D}. If Pₖ*<Pₘₐₓ, then the motor is directly adjusted according to the reference power Pₖ* and the PID parameters K_{P}, K_{I}, and K_{D}.

A PID control calculation formula is:

$$u ( t ) = {K}_{P} \cdot E ( t ) + {K}_{I} \cdot {\int }_{0}^{t} E ( τ ) d τ + {K}_{D} \cdot \frac{dE ( t )}{dt} \qquad ( 17 )$$

where u(t) is an output of a PID controller at the current time, E(t) is an error function at the current time,

$${\int }_{0}^{t} E ( τ ) d τ$$

represents an integral of the error function E(t), i.e., the accumulation of error signals over time, and

$$\frac{dE ( t )}{dt}$$

represents a derivative of the error function E(t), i.e., a changing rate of the error signals over time.

### Experiment

The yellowing apparatus based on multi-physics coupling as described in Example 1 was used, and the method for optimizing process control system parameters using the yellowing apparatus based on multi-physics coupling was employed to perform yellowing processing on 15 kg of tea leaves having a moisture content of about 50%.

Comparative Example 1-1: A conventional yellowing device and yellowing method were used as a control. The conventional yellowing device included a heat source (an electric heating basket) and cloth bags. The electric heating basket was heated to about 85 °C. The tea leaves under processing (with the moisture content of about 50%) were manually packed into the cloth bags at 1 kg per bag, and then the bags were placed on the electric heating basket. After standing for 15 to 20 minutes, each bag was manually unpacked, and the tea leaves were shaken for separate. The tea leaves were then repacked and placed back on the electric heating basket. This process was repeated for a total of 4 to 8 hours until the tea leaves under processing reached a suitable degree of yellowing.

Comparative Example 1-2: An ordinary drum device was used as a control, which includes a bearing frame, a drum, and a blower device. A heating pipe was laid at the bottom inside the drum. The blower device was used for ventilating the interior of the drum, with the inlet air being natural air. For yellowing treatment, 15 kg of tea leaves under processing having a moisture content of about 50% were uniformly placed in the drum. The temperature was set to 120 °C. After the heating pipe was turned on, the temperature inside the drum increased. When the temperature inside the drum was manually measured to be 80 °C or above, the drum rotation was immediately started and ventilation was turned on. After appropriate cooling, ventilation and rotation were stopped, and the drum was kept stationary. This control process was repeated until a suitable degree of yellowing was achieved.

The yellowing process of Example 1, Comparative Example 1-1, and Comparative Example 1-2 was each repeated three times. The sensory quality of tea leaf samples after yellowing from Example 1 and the comparative examples was manually evaluated using the national standard method (GB/T 23776-2018), and descriptions and scores were given. The sensory evaluation method was as follows: ten evaluators sensitive to the shape and aroma of yellow tea were selected. Preliminary simulation evaluations showed that these sensory evaluators were able to distinguish differences in aroma and appearance of yellow tea at different levels. The evaluation scores given by the ten evaluators for the same example or comparative example samples were statistically analyzed. Outliers were analyzed and removed using the Q-test method, and then the evaluation scores were averaged. The results obtained are shown below (see Table 1).

TABLE 1
Sensory Quality Characteristics and Stability Evaluation of Yellowing Samples of Example and Comparative Examples

| | | Appearance | | Liquor color | | Aroma | | Taste | | Infused leaves | | Total |
|---|---|---|---|---|---|---|---|---|---|---|---|---|
| Group | | Description | Score | Description | Score | Description | Score | Description | Score | Description | Score | score |
| Example 1 | Repetition 1 | Tightly | 93 | Tender | 94 | Sweet, | 94 | Mellow and | 94 | Tender and | 93 | 93.65 |
| | | curled, | | yellow and | | pure, and | | sweet, | | uniform with | | |
| | | tender | | bright | | relatively | | relatively | | many buds, | | |
| | | yellow, and | | | | rich | | sweet and | | tender | | |
| | | relatively | | | | | | brisk, | | yellow, and | | |
| | | glossy | | | | | | smooth and | | bright | | |
| | | | | | | | | silky | | | | |
| | Repetition 2 | Tightly | 93 | Tender | 94 | Sweet, | 94 | Mellow and | 94 | Tender and | 93 | 93.65 |
| | | curled, | | yellow and | | pure, and | | sweet, | | uniform with | | |
| | | tender | | bright | | relatively | | relatively | | many buds, | | |
| | | yellow, and | | | | rich | | sweet and | | tender | | |
| | | relatively | | | | | | brisk, | | yellow, and | | |
| | | glossy | | | | | | smooth and | | bright | | |
| | | | | | | | | silky | | | | |
| | Repetition 3 | Tightly | 93 | Tender | 94 | Sweet, | 94 | Mellow and | 94 | Tender and | 93 | 93.65 |
| | | curled, | | yellow and | | pure, and | | sweet, | | uniform with | | |
| | | tender | | bright | | relatively | | relatively | | many buds, | | |
| | | yellow, and | | | | rich | | sweet and | | tender | | |
| | | relatively | | | | | | brisk, | | yellow, and | | |
| | | glossy | | | | | | smooth and | | bright | | |
| | | | | | | | | silky | | | | |
| Comparative | Repetition 1 | Tightly | 88 | Relatively | 90 | Fresh and | 92 | Relatively | 90 | Tender and | 92 | 90.20 |
| Example 1-1 | | curled, | | tender | | sweet | | mellow and | | uniform with | | |
| | | relatively | | yellow and | | | | relatively | | many buds, | | |
| | | tender | | bright | | | | sweet | | relatively | | |
| | | yellow, and | | | | | | | | tender | | |
| | | relatively | | | | | | | | yellow, and | | |
| | | variegated | | | | | | | | bright | | |
| | Repetition 2 | Tightly | 93 | Tender | 94 | Sweet, | 94 | Mellow and | 94 | Tender and | 93 | 93.65 |
| | | curled, | | yellow and | | pure, and | | sweet, | | uniform with | | |
| | | tender | | bright | | relatively | | relatively | | many buds, | | |
| | | yellow, and | | | | rich | | sweet and | | tender | | |
| | | relatively | | | | | | brisk, | | yellow, and | | |
| | | glossy | | | | | | smooth and | | bright | | |
| | | | | | | | | silky | | | | |
| | Repetition 3 | Tightly | 92 | Relatively | 93 | Sweet, | 93.5 | Relatively | 93.5 | Tender and | 92 | 92.93 |
| | | curled, | | tender | | pure, and | | sweet and | | uniform with | | |
| | | relatively | | yellow and | | fairly rich | | brisk | | many buds, | | |
| | | tender | | bright | | | | | | relatively | | |
| | | yellow, and | | | | | | | | tender | | |
| | | relatively | | | | | | | | yellow, and | | |
| | | glossy | | | | | | | | bright | | |
| Comparative | Repetition 1 | Tightly | 90 | Relatively | 90 | Fresh and | 92 | Relatively | 90 | Tender and | 92 | 90.70 |
| Example 1-2 | | curled, | | tender | | sweet | | mellow and | | uniform with | | |
| | | relatively | | yellow and | | | | relatively | | many buds, | | |
| | | tender | | relatively | | | | sweet | | relatively | | |
| | | yellow | | bright | | | | | | tender | | |
| | | | | | | | | | | yellow, and | | |
| | | | | | | | | | | bright | | |
| | Repetition 2 | Tightly | 92 | Relatively | 90 | Relatively | 90 | Relatively | 92 | Tender and | 92 | 91.3 |
| | | curled, | | tender | | sweet and | | sweet and | | uniform with | | |
| | | relatively | | yellow and | | pure | | brisk | | many buds, | | |
| | | tender | | relatively | | | | | | relatively | | |
| | | yellow, and | | bright | | | | | | tender | | |
| | | relatively | | | | | | | | yellow, and | | |
| | | glossy | | | | | | | | relatively | | |
| | | | | | | | | | | bright | | |
| | Repetition 3 | Tightly | 92 | Relatively | 92 | Sweet and | 92 | Relatively | 93 | Tender and | 93 | 92.4 |
| | | curled, | | tender | | pure | | mellow, | | uniform with | | |
| | | tender | | yellow and | | | | sweet and | | many buds, | | |
| | | yellow, and | | bright | | | | brisk | | tender | | |
| | | relatively | | | | | | | | yellow, and | | |
| | | glossy | | | | | | | | relatively | | |
| | | | | | | | | | | bright | | |

The comparison results in Table 1 show that, in terms of sensory quality of the samples, compared with Comparative Example 1-1 and Comparative Example 1-2, the samples processed using the device and the yellowing method according to the present disclosure exhibit excellent sensory quality and stable quality. Samples from different batches all exhibit typical and stable yellow tea quality characteristics: a tender yellow and relatively glossy appearance and color, a tender yellow and bright liquor color, a sweet, pure and relatively rich aroma, a mellow, sweet, brisk and smooth taste, and tender yellow and bright infused leaves. In contrast, when yellowing is carried out using the method of Comparative Example 1-1, the descriptions and scores of appearance, liquor color, taste, infused leaves, and the like of the samples from different repetition batches vary significantly, indicating that yellowing carried out using the method of Comparative Example 1-1 cannot stably form typical yellow tea quality characteristics. When yellowing is carried out using the device and method of Comparative Example 1-2, the quality stability is slightly better than that of Comparative Example 1-1, but the overall quality performance is relatively poor.

The motor power during the yellowing process of Example 1 and Comparative Example 1-2 is shown in FIG. 6. In terms of motor power, compared with Comparative Example 1-2, the overall motor power of the yellowing device according to the present disclosure is continuous, and the motor output power can be quickly adjusted in real time according to the temperature, the humidity, and the air pressure inside the yellowing drum, resulting in short processing time and low overall energy consumption. In contrast, when yellowing is carried out using the apparatus of Comparative Example 1-2, the output power can only follow a preset program, and the apparatus power cannot be automatically adjusted according to the yellowing state. Moreover, the process involves a cycle of heating, heat dissipation, and stopping, resulting in long processing time and low energy utilization efficiency.

Finally, it should also be noted that in the examples set forth in this specification, the division of units is merely a logical functional division. In actual implementation, other division manners may be used, for example, multiple units may be combined into one unit, one unit may be split into multiple units, or some features may be omitted. The above are merely several specific examples of the present disclosure. It is apparent that the present disclosure is not limited to the above examples, and may have many variations. All variations that can be directly derived from or conceived based on the content disclosed in the present disclosure by a person of ordinary skill in the art shall be deemed to fall within the scope of protection of the present disclosure.

What is claimed is:

1. A method for optimizing process parameters using a yellowing apparatus based on multi-physics coupling, wherein the yellowing apparatus comprises a drum (2) and a control system (11);
the drum (2) comprises an outer fixed casing (3) and an inner rotating drum (4), wherein one end of the inner rotating drum (4) is a conical inlet/outlet port (5), and the other end is an air inlet; a blower device (8), a drive device (9), and a sensing system (10) are provided on the side of the air inlet; the drive device (9) comprises a motor, wherein the motor is respectively in transmission connection with the inner rotating drum (4) and the blower device (8) via belt transmission to respectively drive the inner rotating drum (4) to rotate and drive the blower device (8) to blow air into the inner rotating drum (4);
the control system (11) comprises a clock module, a BP neural network module, a central processing module, a motor power detector, and a variable frequency controller, wherein the BP neural network module, the sensing system (10), and the clock module are respectively in signal communication with the central processing module;
the motor of the drive device (9) is in signal communication with the central processing module via the variable frequency controller and the motor power detector; and
the sensing system (10) comprises a temperature sensor, an air pressure sensor, and a humidity sensor;
wherein the method comprises:
collecting, in real time by the temperature sensor, the air pressure sensor, and the humidity sensor, data of temperature, relative air humidity, and air pressure inside the drum (2), detecting, by the motor power detector, a motor power at a current yellowing time t, and transmitting the data to the central processing module; determining whether the current yellowing time t is less than a yellowing time tₘₐₓ, and if the yellowing time tₘₐₓ has been reached, turning off the motor; and if the yellowing time tₘₐₓ has not been reached, calculating a saturated water vapor pressure e_{w} and an air density ρ at the current yellowing time t, obtaining, using a real-time trained BP neural network, optimal PID regulation parameters K_{P}, K_{I}, K_{D} and a reference power Pₖ* of the motor at a current moment, and then performing PID control on a rotation speed of the motor and a yellowing duration by the variable frequency controller.

2. The method for optimizing process parameters using the yellowing apparatus based on multi-physics coupling according to claim 1, wherein
the saturated water vapor pressure e_{w} is:
$${e}_{w} = k \times {e}^{( {AT}^{2} + BT + C + \frac{D}{T} )} \qquad ( 14 )$$
wherein e_{w} is the saturated water vapor pressure at temperature T; T is the temperature inside the drum (2); k, A, B, C, and D are constants; and
the air density ρ is:
$$ρ = 3.484 \times 1 {0}^{- 3} \times \frac{1}{T} ( p - 0.3 \; 78 φ {e}_{w} ) \qquad ( 15 )$$
wherein p is the air pressure inside the drum (2), and φ is the relative air humidity inside the drum (2).

3. The method for optimizing process parameters using the yellowing apparatus based on multi-physics coupling according to claim 2, wherein
the BP neural network comprises an input layer, at least one hidden layer, and an output layer:
(1) inputs of the BP neural network are: the temperature, the humidity, the saturated water vapor pressure e_{w}, and the air density ρ inside the drum (2);
(2) inputs and outputs of the hidden layer are calculated according to a forward network of the BP neural network:
$${a}_{j} = f ( {\sum }_{i = 1}^{I} {w}_{ij} {x}_{i} + {b}_{j} ) , ( j = 1 , 2 , … , H ) \qquad ( 2 )$$
wherein xᵢ is an input vector, aⱼ is an output vector of the hidden layer, wᵢⱼ is a weight between the input layer and the hidden layer, bⱼ is a threshold between the input layer and the hidden layer, and f(⋅) is an activation function:
$$f ( x ) = \frac{1}{1 + {e}^{- x}} \qquad ( 3 )$$
(3) outputs of the BP neural network are: the motor reference power Pₖ*, a PID control proportional parameter K_{P}, a PID control integral parameter K_{I}, and a PID control derivative parameter K_{D}:
$${P}_{k}^{*} = f ( {\sum }_{j = 1}^{H} {w}_{jk} {a}_{j} + {b}_{k} ) , ( k = 1 , 2 , … , O ) \qquad ( 4 )$$
wherein wⱼₖ is a weight between the hidden layer and the output layer, and bₖ is a threshold between the hidden layer and the output layer;
$${K}_{P} = g ( {\sum }_{j = 1}^{P} {w}_{jk} {a}_{j} + {b}_{k} ) , ( k = 1 , 2 , … , O ) \qquad ( 5 )$$
$${K}_{I} = g ( {\sum }_{j = 1}^{I} {w}_{jk} {a}_{j} + {b}_{k} ) , ( k = 1 , 2 , … , O ) \qquad ( 6 )$$
$${K}_{D} = g ( {\sum }_{j = 1}^{D} {w}_{jk} {a}_{j} + {b}_{k} ) , ( k = 1 , 2 , … , O ) \qquad ( 7 )$$
wherein K_{P} is the proportional parameter, K_{I} is the integral parameter, and K_{D} is the derivative parameter,
$$g ( x ) = \frac{{e}^{x}}{{e}^{x} + {e}^{- x}} . \qquad ( 8 )$$

4. The method for optimizing process parameters using the yellowing apparatus based on multi-physics coupling according to claim 3, wherein
a real-time training process of the BP neural network comprises:
performing normalization processing on the temperature T, the relative air humidity φ, the saturated water vapor pressure e_{w}, and the air density ρ inside the drum (2) at the current time as well as the motor power, and using the normalized values as the inputs of the BP neural network; initializing the BP neural network, wherein the weights and the thresholds wᵢⱼ, wⱼₖ, bⱼ, and bₖ of the neural network are set as random numbers in an interval [0, 1], and initializing a learning coefficient η; and using a gradient descent algorithm to adjust the weights and the thresholds wᵢⱼ, bⱼ, wⱼₖ, and bₖ of the BP neural network according to the learning coefficient η, performing iterative learning until an error function E converges to a global minimum or a maximum number of training iterations is reached, and then stopping training to obtain optimal weights and thresholds of the BP neural network.

5. The method for optimizing process parameters using the yellowing apparatus based on multi-physics coupling according to claim 4, wherein
the error function E is:
$$E = \frac{1}{2} {\sum }_{k = 1}^{O} {( {P}_{k}^{*} - {P}_{k} )}^{2} , ( k = 1 , 2 , … , O ) \qquad ( 9 )$$
wherein Pₖ* is a reference power obtained after one forward computation of the neural network, and Pₖ is an actual value; and
the weights and thresholds wᵢⱼ, bⱼ, wⱼₖ, and bₖ are:
$${w}_{ij}^{*} = {w}_{ij} + η \frac{\partial E}{\partial {w}_{ij}} \qquad ( 10 )$$
$${b}_{j}^{*} = {b}_{j} + η \frac{\partial E}{\partial {b}_{j}} \qquad ( 11 )$$
$${w}_{jk}^{*} = {w}_{jk} + η \frac{\partial E}{\partial {w}_{jk}} \qquad ( 12 )$$
$${b}_{k}^{*} = {b}_{k} + η \frac{\partial E}{\partial {b}_{k}} \qquad ( 13 )$$
wherein wᵢⱼ* is an updated weight between the input layer and the hidden layer, bⱼ* is an updated threshold between the input layer and the hidden layer, wⱼₖ* is an updated weight between the hidden layer and the output layer, and bₖ* is an updated threshold between the hidden layer and the output layer.

6. The method for optimizing process parameters using the yellowing apparatus based on multi-physics coupling according to claim 5, wherein
a PID control process comprises:
determining whether the output motor reference power Pₖ* is less than a maximum power Pₘₐₓ of the motor, if Pₖ*≥Pₘₐₓ, then setting Pₖ*=Pₘₐₓ, and adjusting the motor according to the reference power Pₖ* and the PID parameters K_{P}, K_{I}, and K_{D}, and if Pₖ*<Pₘₐₓ, then directly adjusting the motor according to the reference power Pₖ* and the PID parameters K_{P}, K_{I}, and K_{D}; and
a PID control calculation formula is:
$$u ( t ) = {K}_{P} \cdot E ( t ) + {K}_{I} \cdot {\int }_{0}^{t} E ( τ ) d τ + {K}_{D} \cdot \frac{dE ( t )}{dt} \qquad ( 17 )$$
wherein u(t) is an output of a PID controller at the current time, E(t) is an error function at the current time,
$${\int }_{0}^{t} E ( τ ) d τ$$
represents an integral of the error function E(t), and
$$\frac{dE ( t )}{dt}$$
represents a derivative of the error function E(t).
